(19) United States
(12) Patent Application Publication
(10) Pub. No.: US 2026/0089702 A1
(43) Pub. Date: Mar. 26, 2026

(54) SERVICE-BASED ALLOCATION OF BANDWIDTH PARTS

(71) Applicant: AT&T Intellectual Property I, L.P., Atlanta, GA (US)

(72) Inventors: Jianchun Zhou, Bellevue, WA (US); Yakun Gao, Suwanee, GA (US); Ratish Upadhyay, Frisco, TX (US)

(21) Appl. No.: 18/893,933

(22) Filed: Sep. 23, 2024

(51) Int. Cl. H04W 72/0457

(52) U.S. Cl. CPC H04W 72/0457

(57) ABSTRACT

A method performed by a processing system including at least one processor includes allocating a full bandwidth of a radio channel of a radio access network to a user endpoint device, detecting the user endpoint device activating a service that is associated with a bandwidth part of the radio channel, wherein the bandwidth part comprises less than an entirety of the full bandwidth, and adjusting, in response to the detecting, an amount of a bandwidth of the radio channel that is allocated to the user endpoint device from the full bandwidth to the bandwidth part.

The present disclosure relates generally to wireless communications and relates more particularly to devices, non-transitory computer-readable media, and methods for service-based allocation of bandwidth parts.

### BACKGROUND

Bandwidth part (BWP) is a mechanism in 5G new radio (NR) communications that improves the energy efficiency of a user endpoint device by allowing the user endpoint device to utilize a segment of a radio channel rather than the entire radio channel (e.g., a twenty megahertz segment of a one hundred megahertz channel). The ability to utilize less than the entirety of the radio channel may be particularly beneficial when the user endpoint device is utilizing applications that require relatively low bit rates, such as Voice over New Radio (VoNR), or in situations where the user endpoint device cannot utilize the full bandwidth of the radio channel.

### SUMMARY

In one example, the present disclosure describes a device, computer-readable medium, and method for service-based allocation of bandwidth parts. For instance, in one example, a method performed by a processing system including at least one processor includes allocating a full bandwidth of a radio channel of a radio access network to a user endpoint device, detecting the user endpoint device activating a service that is associated with a bandwidth part of the radio channel, wherein the bandwidth part comprises less than an entirety of the full bandwidth, and adjusting, in response to the detecting, an amount of a bandwidth of the radio channel that is allocated to the user endpoint device from the full bandwidth to the bandwidth part.

In another example, a non-transitory computer-readable medium stores instructions which, when executed by a processor, cause the processor to perform operations. The operations include allocating a full bandwidth of a radio channel of a radio access network to a user endpoint device, detecting the user endpoint device activating a service that is associated with a bandwidth part of the radio channel, wherein the bandwidth part comprises less than an entirety of the full bandwidth, and adjusting, in response to the detecting, an amount of a bandwidth of the radio channel that is allocated to the user endpoint device from the full bandwidth to the bandwidth part.

In another example, a device includes a processor and a computer-readable medium storing instructions which, when executed by the processor, cause the processor to perform operations. The operations include allocating a full bandwidth of a radio channel of a radio access network to a user endpoint device, detecting the user endpoint device activating a service that is associated with a bandwidth part of the radio channel, wherein the bandwidth part comprises less than an entirety of the full bandwidth, and adjusting, in response to the detecting, an amount of a bandwidth of the radio channel that is allocated to the user endpoint device from the full bandwidth to the bandwidth part.

### BRIEF DESCRIPTION OF THE DRAWINGS

The teachings of the present disclosure can be readily understood by considering the following detailed description in conjunction with the accompanying drawings, in which:

FIG. 1 illustrates an example network, or system, in which examples of the present disclosure may operate;

FIG. 2 illustrates a flowchart of an example method for service-based allocation of bandwidth parts, in accordance with the present disclosure;

FIG. 3 illustrates a table showing example bandwidth parts and search spaces that may be defined for different services depending upon the delay class, bit rate, quality of service class indicator, and buffer fill level associated with the services;

FIG. 4 illustrates a table showing example services that may be associated with different combinations of fifth generation quality of service identifiers, resource types, priority levels, delay budgets, error rates, data burst volumes, and averaging windows; and

FIG. 5 depicts a high-level block diagram of a computing device specifically programmed to perform the functions described herein.

To facilitate understanding, identical reference numerals have been used, where possible, to designate identical elements that are common to the figures.

### DETAILED DESCRIPTION

In one example, the present disclosure implements service-based allocation of bandwidth parts. As discussed above, bandwidth part (BWP) is a mechanism in 5G new radio (NR) communications that improves the energy efficiency of a user endpoint device by allowing the user endpoint device to utilize a segment of a radio channel rather than the entire radio channel (e.g., a twenty megahertz segment of a one hundred megahertz channel). The ability to utilize less than the entirety of the radio channel may be particularly beneficial when the user endpoint device is utilizing applications that require relatively low bit rates, such as Voice over New Radio (VoNR), or in situations where the user endpoint device cannot utilize the full bandwidth of the radio channel.

BWP can be implemented in either the frequency domain or the time domain. When implemented in the frequency domain, the entire bandwidth of the radio channel is narrowed down to a partial bandwidth. When implemented in the time domain, transmission time interval (TTI) resources may be leveraged. In both cases, the demand on the user endpoint devices to monitor the power control channel (PDCCH) may be lowered in an attempt to lower power consumption by the user endpoint devices. Also in both cases, a buffer-based mechanism may be used to dynamically switch between BWP and full bandwidth. Switching between BWP and full bandwidth is typically facilitated through downlink control information (DCI).

The amount of data in the buffer can fluctuate rapidly due to the bursty nature of traffic from multiple transmission control protocol/Internet protocol (TCP/IP) pathways, multiple data streams, and a diverse set of server-side buffer algorithms. This may result in rapid switching between BWP and full bandwidth, which consumes a great deal of DCI resources and therefore limits the amount of power that can be conserved in the user endpoint devices due to BWP. Moreover, unlike standard DCIs, the first DCIs designed specifically to facilitate BWP operations do not typically allocate physical downlink shared channel (PDSCH), which forces the user endpoint devices to utilize additional power monitoring and receiving PDSCH signals.

Time-based BWP also face additional challenges. For instance, user endpoint devices that are incapable of supporting the full bandwidth (e.g., devices designed for reduced capability, Internet of Things, and lower-tier devices) typically see little to no benefit from time-based BWP. There is also little to no improvement in uplink (UL) power efficiency, since UL still utilizes the full bandwidth. Additionally, extra delays are often introduced due to time-based BWP using only a portion of the TTI resources.

Thus, while BWP switching offers the potential for energy savings, current BWP implementations offer limited gains in power efficiency, especially in dynamic environments characterized by rapid changes in buffer size.

Examples of the present disclosure switch between BWP and full bandwidth utilization based on the services or applications that are currently being used by the user endpoint devices. Further examples of the present disclosure allocate a bandwidth part to a user endpoint device based on delay sensitivity when switching to BWP, where bandwidth parts of different sizes or amounts may be allocated to different types of services or applications depending upon the applications' sensitivities to delay and/or other considerations. This allows user endpoint devices that are using services that are relatively insensitive to delay to conserve energy by consistently utilizing BWP for those services without compromising the performance of the services. User endpoint devices that are using more delay sensitive services may utilize BWP with larger BWP allocations or may use full bandwidth to ensure consistent high performance.

Examples of the present disclosure optimize network control signaling by eliminating frequent switches between BWP and full bandwidth, thereby significantly reducing DCI volume. This reduces overhead and enhances the overall performance of the wireless network. Examples of the present disclosure may also provide enhanced power efficiency for critical services whose bitrate requirements are relatively low but which are sensitive to delays. For long-running services in particular, optimizing the bandwidth usage may result in more substantial power conservation. This may significantly extend the battery life of user endpoint devices using the services and thus ensure service continuity.

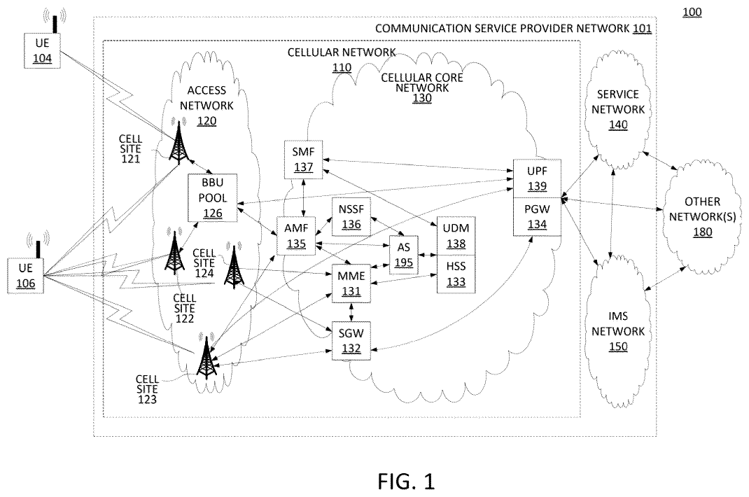

Further examples of the present disclosure may improve the handling of bursty traffic for services that have higher bandwidth requirements but are less sensitive to delay by implementing a sparse PDCCH search to provide more optimal resource allocation and service quality. Thus, combining the implementation of a specific bandwidth part for a service with sparse PDCCH monitoring (as opposed to full monitoring) of the radio channel according to the delay sensitivity of the service (e.g., delay-sensitive, non-delay-sensitive, low data rate, or high data rate) may lead to further conservation of power by the user endpoint device. These and other aspects of the present disclosure are discussed in greater detail in connection with FIGS. 1-5, below.

FIG. 1 illustrates an example network, or system, 100 in which examples of the present disclosure may operate. In one example, the system 100 includes a communication service provider network 101. The communication service provider network 101 may comprise a cellular network 110 (e.g., a 5G network, a 4G/Long Term Evolution (LTE)/5G hybrid network, or the like), a service network 140, and an IP Multimedia Subsystem (IMS) network 150. The system 100 may further include other networks 180 connected to the communication service provider network 101.

In one example, the cellular network 110 comprises an access network 120 and a cellular core network 130. In one example, the access network 120 comprises a cloud RAN. A cloud RAN, however, is just one example of a RAN with which MU-MIMO may work. MU-MIMO works with all types of RANs, including distributed RANS (D-RANs), centralized RANs (C-RANs), virtualized RANS (V-RANs), and open RANS (O-RANs).

For instance, a cloud RAN is part of the 3GPP 5G specifications for mobile networks. As part of the migration of cellular networks towards 5G, a cloud RAN may be coupled to an Evolved Packet Core (EPC) network until new cellular core networks are deployed in accordance with 5G specifications. In one example, access network 120 may include cell sites 121 and 122 and a baseband unit (BBU) pool 126. In a cloud RAN, radio frequency (RF) components, referred to as remote radio heads (RRHs) or radio units (RUs), may be deployed remotely from baseband units, e.g., atop cell site masts, buildings, and so forth. In one example, the BBU pool 126 may be located at distances as far as 20-80 kilometers or more away from the antennas/remote radio heads of cell sites 121 and 122 that are serviced by the BBU pool 126. It should also be noted in accordance with efforts to migrate to 5G networks, cell sites may be deployed with new antenna and radio infrastructures such as MIMO antennas, and millimeter wave antennas.

Although cloud RAN infrastructure may include distributed RRHs and centralized baseband units, a heterogeneous network may include cell sites where RRH and BBU components remain co-located at the cell site. For instance, cell site 123 may include RRH and BBU components. Thus, cell site 123 may comprise a self-contained “base station.” With regard to cell sites 121 and 122, the “base stations” may comprise RRHs at cell sites 121 and 122 coupled with respective baseband units of BBU pool 126. In one example, baseband unit functionality may be split into a centralized unit (CU) and a distributed unit (DU). In addition, the CU and the DU may be physically separate from one another. For instance, a DU may be situated with an RU/RRH at a cell site, while a CU may be in a centralized location hosting multiple CUs. Alternatively, or in addition, a single CU may serve multiple DUs and/or RUs/RRHs. In accordance with the present disclosure a “base station” may therefore comprise at least a BBU (e.g., in one example, a CU and/or a DU), and may further include at least one RRH/RU.

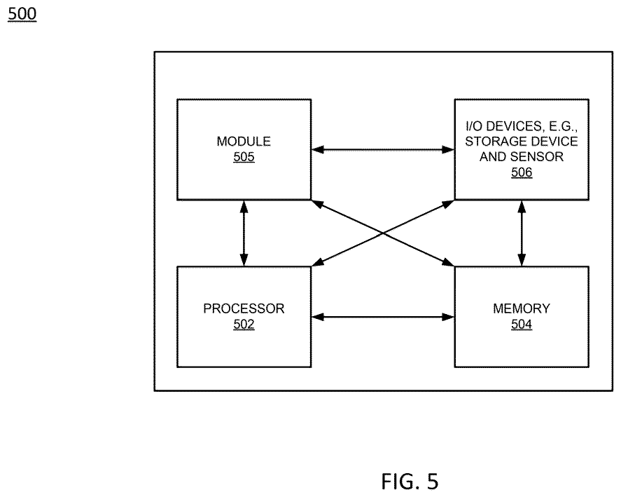

In accordance with the present disclosure, any one or more of cell sites 121-124 may be deployed with antenna and radio infrastructures, including MIMO and millimeter wave antennas. Furthermore, in accordance with the present disclosure, a base station (e.g., cell sites 121-124 and/or baseband units within BBU pool 126) may comprise all or a portion of a computing system, such as computing system 500 as depicted in FIG. 5, and may be configured to perform steps, functions, and/or operations in connection with examples of the present disclosure for service-based allocation of bandwidth parts.

In one example, access network 120 may include both 4G/LTE and 5G/NR radio access network infrastructure. For example, access network 120 may include cell site 124, which may comprise 4G/LTE base station equipment, e.g., an eNodeB. In addition, access network 120 may include cell sites comprising both 4G and 5G base station equipment, e.g., respective antennas, feed networks, baseband equipment, and so forth. For instance, cell site 123 may include both 4G and 5G base station equipment and corresponding connections to 4G and 5G components in cellular core network 130. Although access network 120 is illustrated as including both 4G and 5G components, in another example, 4G and 5G components may be considered to be contained within different access networks. Nevertheless, such different access networks may have a same wireless coverage area, or fully or partially overlapping coverage areas.

In one example, the cellular core network 130 provides various functions that support wireless services in the LTE environment. In one example, cellular core network 130 is an Internet Protocol (IP) packet core network that supports both real-time and non-real-time service delivery across a LTE network, e.g., as specified by the 3GPP standards. In one example, cell sites 121 and 122 in the access network 120 are in communication with the cellular core network 130 via baseband units in BBU pool 126.

In cellular core network 130, network nodes such as Mobility Management Entity (MME) 131 and Serving Gateway (SGW) 132 support various functions as part of the cellular network 110. For example, MME 131 is the control node for LTE access network components, e.g., eNodeB aspects of cell sites 121-123. In one embodiment, MME 131 is responsible for UE (User Equipment) tracking and paging (e.g., such as retransmissions), bearer activation and deactivation process, selection of the SGW, and authentication of a user. In one embodiment, SGW 132 routes and forwards user data packets, while also acting as the mobility anchor for the user plane during inter-cell handovers and as an anchor for mobility between 5G, LTE and other wireless technologies, such as 2G and 3G wireless networks.

In addition, cellular core network 130 may comprise a Home Subscriber Server (HSS) 133 that contains subscription-related information (e.g., subscriber profiles), performs authentication and authorization of a wireless service user, and provides information about the subscriber's location. The cellular core network 130 may also comprise a packet data network (PDN) gateway (PGW) 134 which serves as a gateway that provides access between the cellular core network 130 and various packet data networks (PDNs), e.g., service network 140, IMS network 150, other network(s) 180, and the like.

The foregoing describes long term evolution (LTE) cellular core network components (e.g., EPC components). In accordance with the present disclosure, cellular core network 130 may further include other types of wireless network components e.g., 5G network components, 3G network components, etc. Thus, cellular core network 130 may comprise an integrated network, e.g., including any two or more of 2G-5G infrastructures and technologies (or any future infrastructures and technologies to be deployed, e.g., 6G), and the like. For example, as illustrated in FIG. 1, cellular core network 130 further comprises 5G components, including: an access and mobility management function (AMF) 135, a network slice selection function (NSSF) 136, a session management function (SMF) 137, a unified data management function (UDM) 138, and a user plane function (UPF) 139.

In one example, AMF 135 may perform registration management, connection management, endpoint device reachability management, mobility management, access authentication and authorization, security anchoring, security context management, coordination with non-5G components, e.g., MME 131, and so forth. NSSF 136 may select a network slice or network slices to serve an endpoint device, or may indicate one or more network slices that are permitted to be selected to serve an endpoint device. For instance, in one example, AMF 135 may query NSSF 136 for one or more network slices in response to a request from an endpoint device to establish a session to communicate with a PDN. The NSSF 136 may provide the selection to AMF 135, or may provide one or more permitted network slices to AMF 135, where AMF 135 may select the network slice from among the choices. A network slice may comprise a set of cellular network components, such as AMF(s), SMF(s), UPF(s), and so forth that may be arranged into different network slices which may logically be considered to be separate cellular networks. In one example, different network slices may be preferentially utilized for different types of services. For instance, a first network slice may be utilized for sensor data communications, Internet of Things (IoT), and machine-type communication (MTC), a second network slice may be used for streaming video services, a third network slice may be utilized for voice calling, a fourth network slice may be used for gaming services, and so forth.

In one example, SMF 137 may perform endpoint device IP address management, UPF selection, UPF configuration for endpoint device traffic routing to an external packet data network (PDN), charging data collection, quality of service (QoS) enforcement, and so forth. UDM 138 may perform user identification, credential processing, access authorization, registration management, mobility management, subscription management, and so forth. As illustrated in FIG. 1, UDM 138 may be tightly coupled to HSS 133. For instance, UDM 138 and HSS 133 may be co-located on a single host device, or may share a same processing system comprising one or more host devices. In one example, UDM 138 and HSS 133 may comprise interfaces for accessing the same or substantially similar information stored in a database on a same shared device or one or more different devices, such as subscription information, endpoint device capability information, endpoint device location information, and so forth. For instance, in one example, UDM 138 and HSS 133 may both access subscription information or the like that is stored in a unified data repository (UDR) (not shown).

UPF 139 may provide an interconnection point to one or more external packet data networks (PDN(s)) and perform packet routing and forwarding, QoS enforcement, traffic shaping, packet inspection, and so forth. In one example, UPF 139 may also comprise a mobility anchor point for 4G-to-5G and 5G-to-4G session transfers. In this regard, it should be noted that UPF 139 and PGW 134 may provide the same or substantially similar functions, and in one example, may comprise the same device, or may share a same processing system comprising one or more host devices.

It should be noted that other examples may comprise a cellular network with a “non-stand alone” (NSA) mode architecture where 5G radio access network components, such as a “new radio” (NR), “gNodeB” (or “gNB”), and so forth are supported by a 4G/LTE core network (e.g., an EPC network), or a 5G “standalone” (SA) mode point-to-point or service-based architecture where components and functions of an EPC network are replaced by a 5G core network (e.g., a “5GC”). For instance, in non-standalone (NSA) mode architecture, LTE radio equipment may continue to be used for cell signaling and management communications, while user data may rely upon a 5G new radio (NR), including millimeter wave communications, for example. However, examples of the present disclosure may also relate to a hybrid, or integrated 4G/LTE-5G cellular core network such as cellular core network 130 illustrated in FIG. 1. In this regard, FIG. 1 illustrates a connection between AMF 135 and MME 131, e.g., an “N26” interface which may convey signaling between AMF 135 and MME 131 relating to endpoint device tracking as endpoint devices are served via 4G or 5G components, respectively, signaling relating to handovers between 4G and 5G components, and so forth.

In one example, service network 140 may comprise one or more devices for providing services to subscribers, customers, and or users. For example, communication service provider network 101 may provide a cloud storage service, web server hosting, and other services. As such, service network 140 may represent aspects of communication service provider network 101 where infrastructure for supporting such services may be deployed. In one example, other networks 180 may represent one or more enterprise networks, a circuit switched network (e.g., a public switched telephone network (PSTN)), a cable network, a digital subscriber line (DSL) network, a metropolitan area network (MAN), an Internet service provider (ISP) network, and the like. In one example, the other networks 180 may include different types of networks. In another example, the other networks 180 may be the same type of network. In one example, the other networks 180 may represent the Internet in general. In this regard, it should be noted that any one or more of service network 140, other networks 180, or IMS network 150 may comprise a packet data network (PDN) to which an endpoint device may establish a connection via cellular core network 130 in accordance with the present disclosure.

In one example, any one or more of the components of cellular core network 130 may comprise network function virtualization infrastructure (NFVI), e.g., SDN host devices (i.e., physical devices) configured to operate as various virtual network functions (VNFs), such as a virtual MME (vMME), a virtual HHS (vHSS), a virtual serving gateway (vSGW), a virtual packet data network gateway (vPGW), and so forth. For instance, MME 131 may comprise a vMME, SGW 132 may comprise a vSGW, and so forth. Similarly, AMF 135, NSSF 136, SMF 137, UDM 138, and/or UPF 139 may also comprise NFVI configured to operate as VNFs. In addition, when comprised of various NFVI, the cellular core network 130 may be expanded (or contracted) to include more or less components than the state of cellular core network 130 that is illustrated in FIG. 1. It should be noted that intermediate devices and links between MME 131, SGW 132, cell sites 121-124, PGW 134, AMF 135, NSSF 136, SMF 137, UDM 138, and/or UPF 139, and other components of system 100 are also omitted for clarity, such as additional routers, switches, gateways, and the like.

FIG. 1 also illustrates various endpoint devices, e.g., user equipment (UE) 104 and 106. Each of the UEs 104 and 106 may comprise a cellular telephone, a smartphone, a tablet computing device, a laptop computer, a pair of computing glasses, a wireless enabled wristwatch, a wireless transceiver for a wireless broadband (FWB) deployment, or any other cellular-capable mobile telephony and computing device (broadly, “an endpoint device”). For instance, each of the UEs 104 and 106 may include one or more radio frequency (RF) transceivers for cellular communications and/or for non-cellular wireless communications. In one example, each of the UEs 104 and 106 may be equipped with one or more directional antennas, or antenna arrays (e.g., having a half-power azimuthal beamwidth of 120 degrees or less, 90 degrees or less, 60 degrees or less, etc.), e.g., MIMO antenna(s) to receive and/or to transmit multi-path and/or spatial diversity signals.

In one example, each of the UEs 104 and 106 may comprise all or a portion of a computing system, such as computing system 500 depicted in FIG. 5, and may be configured to perform steps, functions, and/or operations in connection with examples of the present disclosure for service-based allocation of bandwidth parts. In this regard, it should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device including one or more processors, or cores (e.g., as illustrated in FIG. 5 and discussed below) or multiple computing devices collectively configured to perform various steps, functions, and/or operations in accordance with the present disclosure.

As illustrated in FIG. 1, UE 104 may access wireless services via the cell site 121 (e.g., NR alone, where cell site 121 comprises a gNB), while UE 106 may access wireless services via any of the cell sites 121-124 located in the access network 120 (e.g., for NR non-dual connectivity, for LTE non-dual connectivity, for NR-NR DC, for LTE-LTE DC, for EN-DC, and/or for NE-DC). For instance, in one example, UE 106 may establish and maintain connections to the cellular core network 130 via one or multiple gNBs (e.g., cell sites 121 and 122 and/or cell sites 121 and 122 in conjunction with BBU pool 126 and/or various other components, such as a CU and/or a DU). In another example, UE 106 may establish and maintain connections to the cellular core network 130 via a gNB (e.g., cell site 122 and/or cell site 122 in conjunction with BBU pool 126) and an eNodeB (e.g., cell site 124), respectively. In addition, either the gNB or the eNodeB may comprise a PCell, and the other may comprise a SCell for carrier aggregation and/or dual connectivity. Similarly, UE 106 may communicate with any of the cell sites 121 and 122 using carrier aggregation (CA) (e.g., in accordance with a CA technique). Furthermore, either or both of NR/5G and or EPC (4G/LTE) core network components may manage the communications between UE 106 and the cellular network 110 via cell site 122 and cell site 124.

In one example, UE 106 may also utilize different antenna arrays for 4G/LTE and 5G/NR, respectively. For instance, 5G antenna arrays may be arranged for beamforming in a frequency band designated for 5G high data rate communications. For instance, the antenna array for 5G may be designed for operation in a frequency band between 1 GHz and 7.125 GHz. In contrast, an antenna array for 4G may be designed for operation in a frequency band less than 5 GHz, e.g., 500 MHz to 3 GHz. In addition, in one example, the 4G antenna array (and/or the RF or baseband processing components associated therewith) may not be configured for and/or be capable of beamforming. Accordingly, in one example, UE 106 may turn off a 4G/LTE radio, and may activate a 5G radio to send a request to activate a 5G session to cell site 122 (e.g., when it is chosen to operate in a non-DC mode or an intra-RAT dual connectivity mode), or may maintain both radios in an active state for multi-radio (MR) dual connectivity (MR-DC).

In accordance with the present disclosure, UE 106 may attach to any cell (e.g., a cell site/base station) of access network 120 and may provide an identification and an indication of a UE type to the cellular network 110. A radio channel of the cell may carry data between the UE 106 and one or more services supported by elements of the service network 140. In one example, the AS 195 may determine, based on these data transmissions, a nature of the service(s) being used by the UE 106. The AS 195 may then assign a bandwidth part of the radio channel to the UE 106 based on the nature of the service(s) being used. In one example, the bandwidth part comprises less than an entirety of the full bandwidth of the radio channel. The UE 106 may continue to utilize the bandwidth part for as long as the service is in use by the UE 106. Thus, the UE may only switch to a different bandwidth part, or to the full bandwidth, if the UE ceases to use the service and instead activates a different service that is assigned a different bandwidth part. In this way, switching between different bandwidth parts and/or full bandwidth by the UE 106 can be minimized, allowing the UE 106 to conserve power and improve power efficiency, particularly under dynamic network conditions where buffer fill levels may change rapidly.

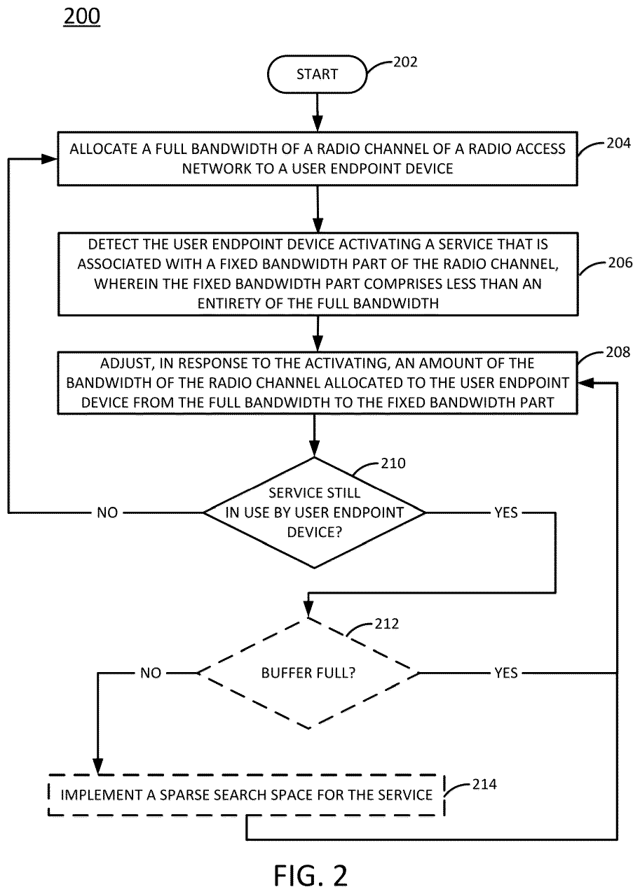

It should be noted that examples of the present disclosure as described herein primarily in connection with steps, functions, and/or operations that are performed by a cellular base station. For instance, FIG. 2 illustrates a flowchart of an example method that may be performed by a serving cell (e.g., a base station and/or any one or more components thereof). However, in other, further, and different examples, various steps, functions, and/or operations as described in connection with FIG. 2, or as described elsewhere herein, may alternatively or additionally be performed by one or more other components. For instance, various steps, functions, and/or operations may alternatively or additionally be performed by a processing system in cellular core network 130, such as application server (AS) 195, AMF 135, SMF 137, MME 131, or the like. To illustrate, in an example in which the foregoing is performed by a base station/cell site, the transmitting of the at least one instruction may be via the base station/cell site to UE 106. However, in an example in which the foregoing may be performed by AS 195, AMF 135, SMF 137, MME 131, or the like, the instruction may be sent to a cell sites/base station serving UE 106 to activate uplink MU-MIMO communications.

The foregoing description of the system 100 is provided as an illustrative example only. In other words, the example of system 100 is merely illustrative of one network configuration that is suitable for implementing examples of the present disclosure. As such, other logical and/or physical arrangements for the system 100 may be implemented in accordance with the present disclosure. For example, the system 100 may be expanded to include additional networks, such as network operations center (NOC) networks, additional access networks, and so forth. The system 100 may also be expanded to include additional network elements such as border elements, routers, switches, policy servers, security devices, gateways, a content distribution network (CDN) and the like, without altering the scope of the present disclosure. In addition, system 100 may be altered to omit various elements, substitute elements for devices that perform the same or similar functions, combine elements that are illustrated as separate devices, and/or implement network elements as functions that are spread across several devices that operate collectively as the respective network elements.

For instance, in one example, the cellular core network 130 may further include a Diameter routing agent (DRA) which may be engaged in the proper routing of messages between other elements within cellular core network 130, and with other components of the system 100, such as a call session control function (CSCF) (not shown) in IMS network 150. In another example, the NSSF 136 may be integrated within the AMF 135. In addition, cellular core network 130 may also include additional 5G NG core components, such as: a policy control function (PCF), an authentication server function (AUSF), a network repository function (NRF), and other application functions (AFs). In one example, any one or more of cell sites 121-124 may comprise 2G, 3G, 4G and/or LTE radios, e.g., in addition to 5G new radio (NR), or gNB functionality. For instance, cell site 123 is illustrated as being in communication with AMF 135 in addition to MME 131 and SGW 132. Thus, these and other modifications are all contemplated within the scope of the present disclosure.

To further aid in understanding the present disclosure, FIG. 2 illustrates a flowchart of an example method 200 for service-based allocation of bandwidth parts, in accordance with the present disclosure. In one example, the method 200 may be performed by an application server that is configured to allocate bandwidth associated with a radio channel of a radio access network, such as the AS 195 illustrated in FIG. 1. However, in other examples, the method 200 may be performed by another device, such as the processor 502 of the system 500 illustrated in FIG. 5. For the sake of example, the method 200 is described as being performed by a processing system.

The method 200 begins in step 202. In step 204, the processing system may allocate a full bandwidth of a radio channel of a radio access network to a user endpoint device.

In one example, as a default, all user endpoint devices that are communicating over a radio channel may be allocated the full bandwidth of the radio channel. In one example, the full bandwidth of the radio channel may be characterized by a default 5G quality of service (QoS) identifier (5QI). This default setting may optimally support non-delay sensitive services running on the user endpoint device (e.g., services that accommodate a delay budget of up to three hundred milliseconds).

In one example, the user endpoint device may comprise a cellular telephone, a smartphone, a tablet computing device, a laptop computer, a pair of computing glasses, a wireless enabled wristwatch, a connected vehicle, a drone, a wireless transceiver for a wireless broadband (FWB) deployment, or any other cellular-capable mobile telephony and computing devices. The processing system may be part of an application server that is in communication with one or more base stations of the radio access network. Alternatively, the processing system may be part of a base station serving a cell of the radio access network, where the user endpoint device is physically located within the serving area of the cell.

In step 206, the processing system may detect the user endpoint device activating a service that is associated with a bandwidth part of the radio channel, wherein the bandwidth part comprises less than an entirety of the full bandwidth. In one example, an operator of the radio access network, a service provider who provides services over the radio access network, and/or an application developer who provides applications that can be accessed via the radio access network may provide a mapping that maps specific services accessible via the radio access network to specific, bandwidth parts that the processing system is to allocate to user devices which activate the specific services. Different services may be associated with different sized bandwidth parts. For instance, at least two services of a plurality of services defined in the mapping may be associated with different sized bandwidth parts (e.g., a first service may be associated with a first bandwidth part, while a second service may be associated with a second bandwidth part that is smaller than the first bandwidth part). In some cases, some different services may be associated with bandwidth parts of equal size.

The size of the bandwidth part that is mapped to each service may be chosen to balance quality of service with conservation of user endpoint device power. As an example, the mapping may define a fixed bandwidth part (e.g., ten megahertz of a one hundred megahertz radio channel) for VoNR. By “fixed,” it is understood that the amount of bandwidth allocated by the bandwidth part will not change as long as the associated service is actively in use by the user endpoint device. In other words, the user endpoint device will continue to utilize the fixed bandwidth part (i.e., without alternating between the fixed bandwidth part and the full bandwidth) at least until the service is no longer in use on the user endpoint device.

In one example, the mapping may categorize each service of a plurality of services into one category of a plurality of categories, where each category of the plurality of categories is assigned a different bandwidth part. For instance, assuming a full bandwidth of one hundred megahertz, a first bandwidth part (e.g., of up to twenty megahertz) may be established for a first category including low bit rate, high delay sensitivity services (e.g., VoNR, ultra reliable and low latency communications (URLCC) services, or the like), with a dense PDCCH search across one hundred percent of TTIs; a second bandwidth part (e.g., of between forty and sixty megahertz) may be established for a second category including medium bit rate, high delay sensitivity services (e.g., real-time gaming, live streaming, video conferencing, or the like), alongside a dense PDCCH search in all TTIs; a third bandwidth part (e.g., of between eighty and one hundred megahertz) may be established for a third category including high bit rate, low delay sensitivity services (e.g., buffer streaming video, email, hypertest transport protocol (HTTP)/file transfer protocol (FTP), or the like), with a sparse PDCCH search covering twenty percent of TTIs; and a fourth bandwidth part (e.g., of between ten and ninety megahertz) may be established for low bitrate, low delay sensitivity services (e.g., enhanced mobile broadband (eMBB), or the like), with adaptive search interval. In the case of the fourth category, the exact size of the bandwidth part may vary based on the delay tolerance and data buffering needs of the services in the fourth category. In one example, a machine learning model (such as a neural network, a support vector machine, a decision tree, a linear regression model, a random forest model, or another type of machine learning model) trained on a set of real time data may be used to learn the optimal allocations of bandwidth parts to different services.

Thus, in general, a size of the bandwidth part assigned to a service (or a category of services) may be inversely proportional to a sensitivity of the service to delay (e.g., the more sensitive the service is to delay, the smaller the bandwidth part). Conversely, the size of the bandwidth part may be directly proportional to a required bitrate of the service (e.g., the higher the required bitrate, the larger the bandwidth part).

In step 208, the processing system may adjust (or maintain in certain scenarios as described below), in response to the activating, an amount of the bandwidth of the radio channel that is allocated to the user endpoint device from the full bandwidth to the bandwidth part. As discussed above, the bandwidth part will be selected by the processing system based on the service that is detected to have been activated in step 206. Thus, activation of the service may result in a smaller amount of bandwidth being allocated to the user endpoint device to save power. In one example, the processing system may send an instruction to the user device that causes the user endpoint device to adjust its bandwidth utilization on the radio channel to the bandwidth part. In another example, the processing system may send an instruction to a base station of the radio access network that serves a cell in which the user endpoint device is physically located, where the instruction causes the base station to adjust an amount of bandwidth that is allocated to the user endpoint device.

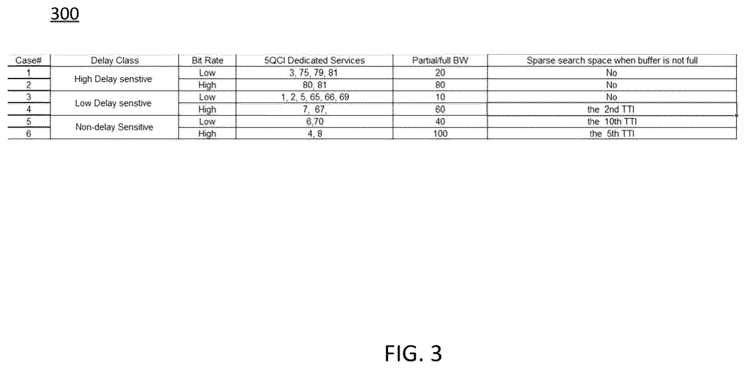

FIG. 3 illustrates a table 300 showing example bandwidth parts and search spaces that may be defined for different services depending upon the delay class, bit rate, QCI, and buffer fill level associated with the services. It will be appreciated that the bandwidth parts and search spaces illustrated in FIG. 3 are examples only, and that different bandwidth parts and/or search spaces may be implemented in other examples for the same combinations of delay class, bit rate, QCI, and buffer fill level.

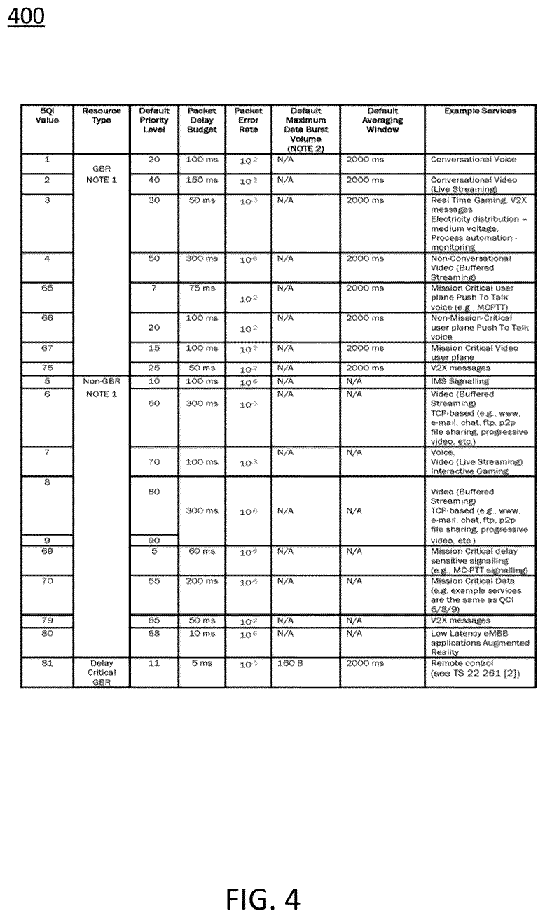

FIG. 4 illustrates a table 400 showing example services that may be associated with different combinations of fifth generation quality of service identifiers, resource types, priority levels, delay budgets, error rates, data burst volumes, and averaging windows.

In step 210, the processing system may determine whether the service is still in user by the user endpoint device. In one example, the processing system may periodically query the user endpoint device, may receive periodic unprompted updates from the user endpoint device, or may examine certain elements of data packets for which the user endpoint device is a source or a destination in order to determine whether the service is still in use on the user endpoint device. In the case where the processing system examines elements of the data packets, the processing system may be programmed to identify a service (or at least a category of service) without examining the contents of the data packets. For instance, the processing system may be able to infer the service or the category of service based on data contained in one or more headers of the data packets, based on membership of the data packets in a common flow, based on resource usage statistics of the common flow, or based on other data that provides a service identification.

If the processing system concludes in step 210 that the service is no longer in use by the user endpoint device, then the method 200 may return to step 204, and the processing system may proceed as described above to restore the full bandwidth of the radio channel to the user endpoint device.

If, however, the processing system concludes in step 210 that the service is still in use by the user endpoint device, then the method 200 may proceed to optional step 212 (illustrated in phantom). In step 212, the processing system may determine whether the buffer of the user endpoint device is full.

If the processing system concludes in step 212 that the buffer is full, then the method 200 may return to step 208, and the processing system may proceed as described above to maintain the amount of the bandwidth of the radio channel that is allocated to the user endpoint device as the bandwidth part.

For instance, as discussed above, the user endpoint device may continue to utilize the bandwidth part (i.e., without alternating between the bandwidth part and the full bandwidth) at least until the service is no longer in use on the user endpoint device. In some examples, the user endpoint device may continue to utilize the bandwidth part even after the service is no longer in use.

If, however, the processing system concludes in step 212 that the buffer is not full, then the method 200 may proceed to step 214.

In step 214, the processing system may implement a sparse search space for the service. Referring again to FIG. 3, the table 300 shows example search spaces that may be defined for different services depending upon delay class, bit rate, QCI, and buffer fill level associated with the services. As shown, for some services, when the buffer is not full, a sparse search space (e.g., second transmission time interval (TTI), tenth TTI, fifth TTI, or the like) may be implemented. As discussed above, implementing a sparse search space for monitoring (as opposed to full monitoring) may help to conserve power at the user endpoint device depending upon the delay sensitivity and/or bit rate of the service.

Once the sparse search space is implemented, the method 200 may then return to step 208, and the processing system may proceed as described above to maintain the amount of the bandwidth of the radio channel that is allocated to the user endpoint device as the bandwidth part.

The processing system may therefore iterate continuously through one or more of steps 204-214 and may continuously adjust the bandwidth part (or full bandwidth) allocated to the user endpoint device. However, because the exact amount of the bandwidth part is selected based on the service (or type of service) that is in use rather than on buffer fill level, the user endpoint device is unlikely to switch between different bandwidth parts and/or full bandwidth as frequently as is seen in BWP schemes that switch based on buffer fill level.

For instance, experimental results have shown that when the bandwidth for VoNR is reduced from one hundred megahertz to a fixed twenty megahertz of a radio channel, the power consumption of the user endpoint device using the VoNR may decrease from approximately 215 milliamps to approximately sixty milliamps. This translates to an almost three hundred percent increase in power efficiency, with little to no sacrifice in performance of the VoNR service.

Although not expressly specified above, one or more steps of the method 200 may include a storing, displaying and/or outputting step as required for a particular application. In other words, any data, records, fields, and/or intermediate results discussed in the method can be stored, displayed and/or outputted to another device as required for a particular application. Furthermore, operations, steps, or blocks in FIG. 2 that recite a determining operation or involve a decision do not necessarily require that both branches of the determining operation be practiced. In other words, one of the branches of the determining operation can be deemed as an optional step. However, the use of the term “optional step” is intended to only reflect different variations of a particular illustrative embodiment and is not intended to indicate that steps not labelled as optional steps to be deemed to be essential steps. Furthermore, operations, steps or blocks of the above described method(s) can be combined, separated, and/or performed in a different order from that described above, without departing from the examples of the present disclosure.

FIG. 5 depicts a high-level block diagram of a computing device specifically programmed to perform the functions described herein. For example, any one or more components or devices illustrated in FIG. 1 or described in connection with the method 200 may be implemented as the system 500. For instance, an application server (such as might be used to perform the method 200) could be implemented as illustrated in FIG. 5.

As depicted in FIG. 5, the system 500 comprises a hardware processor element 502, a memory 504, a module 505 for service-based allocation of bandwidth parts, and various input/output (I/O) devices 506.

The hardware processor 502 may comprise, for example, a microprocessor, a central processing unit (CPU), or the like. The memory 504 may comprise, for example, random access memory (RAM), read only memory (ROM), a disk drive, an optical drive, a magnetic drive, and/or a Universal Serial Bus (USB) drive. The module 505 for service-based allocation of bandwidth parts may include circuitry and/or logic for monitoring services used by user endpoint devices in a radio access network and for adjusting bandwidth parts allocated to the user endpoint devices based on the services. The input/output devices 506 may include, for example, a camera, a video camera, storage devices (including but not limited to, a tape drive, a floppy drive, a hard disk drive or a compact disk drive), a receiver, a transmitter, a speaker, a display, a speech synthesizer, an output port, and a user input device (such as a keyboard, a keypad, a mouse, and the like), or a sensor.

Although only one processor element is shown, it should be noted that the computer may employ a plurality of processor elements. Furthermore, although only one computer is shown in the Figure, if the method(s) as discussed above is implemented in a distributed or parallel manner for a particular illustrative example, i.e., the steps of the above method(s) or the entire method(s) are implemented across multiple or parallel computers, then the computer of this Figure is intended to represent each of those multiple computers. Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a computer or any other hardware equivalents, e.g., computer readable instructions pertaining to the method(s) discussed above can be used to configure a hardware processor to perform the steps, functions and/or operations of the above disclosed method(s). In one example, instructions and data for the present module or process 505 for service-based allocation of bandwidth parts (e.g., a software program comprising computer-executable instructions) can be loaded into memory 504 and executed by hardware processor element 502 to implement the steps, functions or operations as discussed above in connection with the example method 200. Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method(s) can be perceived as a programmed processor or a specialized processor. As such, the present module 505 for service-based allocation of bandwidth parts (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. More specifically, the computer-readable storage device may comprise any physical devices that provide the ability to store information such as data and/or instructions to be accessed by a processor or a computing device such as a computer or an application server.

While various examples have been described above, it should be understood that they have been presented by way of example only, and not limitation. Thus, the breadth and scope of a preferred example should not be limited by any of the above-described example examples, but should be defined only in accordance with the following claims and their equivalents.

What is claimed is:

1. A method comprising:
allocating, by a processing system including at least one processor, a full bandwidth of a radio channel of a radio access network to a user endpoint device;
detecting, by the processing system, the user endpoint device activating a service that is associated with a bandwidth part of the radio channel, wherein the bandwidth part comprises less than an entirety of the full bandwidth; and
adjusting, by the processing system in response to the detecting, an amount of a bandwidth of the radio channel that is allocated to the user endpoint device from the full bandwidth to the bandwidth part.

2. The method of claim 1, wherein the processing system is part of a base station that serves a cell of the radio access network in which the user endpoint device is physically located.

3. The method of claim 1, wherein the adjusting is performed based on a mapping, and wherein the mapping maps each service of a plurality of services including the service activated by the user endpoint device to a respective bandwidth part of a plurality of bandwidth parts.

4. The method of claim 3, wherein at least two services of the plurality of services are mapped to respective bandwidth parts of the plurality of bandwidth parts that are different

5. The method of claim 3, wherein a size of the bandwidth part is inversely proportional to a sensitivity of the service to delay.

6. The method of claim 3, wherein a size of the bandwidth part is directly proportional to a required bitrate of the service.

7. The method of claim 3, wherein sizes of the plurality of bandwidth parts are determined by a machine learning model.

8. The method of claim 1, further comprising:
detecting, by the processing system, the service is no longer in use by the user endpoint device.

9. The method of claim 8, further comprising:
restoring, by the processing system in response to the detecting that the service is no longer in use by the user endpoint device, the full bandwidth of the radio channel to the user endpoint device.

10. The method of claim 9, further comprising:
determining, by the processing system after the restoring, the user endpoint device activating a different service that is associated with a different bandwidth part of the radio channel, wherein the different bandwidth part comprises less than an entirety of the full bandwidth; and
adjusting, in response to the activating the different service, the amount of the bandwidth of the radio channel that is allocated to the user endpoint device from the full bandwidth to the different bandwidth part.

11. The method of claim 1, wherein the bandwidth part is allocated to the user endpoint device for as long as the service is in use by the user endpoint device.

12. The method of claim 1, further comprising:
implementing a sparse power control channel search for the service.

13. A non-transitory computer-readable medium storing instructions which, when executed by a processing system including at least one processor, cause the processing system to perform operations, the operations comprising:
allocating a full bandwidth of a radio channel of a radio access network to a user endpoint device;
detecting the user endpoint device activating a service that is associated with a bandwidth part of the radio channel, wherein the bandwidth part comprises less than an entirety of the full bandwidth; and
adjusting, in response to the detecting, an amount of a bandwidth of the radio channel that is allocated to the user endpoint device from the full bandwidth to the bandwidth part.

14. The non-transitory computer-readable medium of claim 13, wherein the adjusting is performed based on a mapping, and wherein the mapping maps each service of a plurality of services including the service activated by the user endpoint device to a respective bandwidth part of a plurality of bandwidth parts.

15. The non-transitory computer-readable medium of claim 13, the operations further comprising:
detecting the service is no longer in use by the user endpoint device; and
restoring, in response to the detecting that the service is no longer in use by the user endpoint device, the full bandwidth of the radio channel to the user endpoint device.

16. The non-transitory computer-readable medium of claim 15, the operations further comprising:
determining, after the restoring, the user endpoint device activating a different service that is associated with a different bandwidth part of the radio channel, wherein the different bandwidth part comprises less than an entirety of the full bandwidth; and
adjusting, in response to the activating the different service, the amount of the bandwidth of the radio channel that is allocated to the user endpoint device from the full bandwidth to the different bandwidth part.

17. A device comprising:
a processing system including at least one processor; and
a computer-readable medium storing instructions which, when executed by the processing system, cause the processing system to perform operations, the operations comprising:
allocating a full bandwidth of a radio channel of a radio access network to a user endpoint device;
detecting the user endpoint device activating a service that is associated with a bandwidth part of the radio channel, wherein the bandwidth part comprises less than an entirety of the full bandwidth; and
adjusting, in response to the detecting, an amount of a bandwidth of the radio channel that is allocated to the user endpoint device from the full bandwidth to the bandwidth part.

18. The device of claim 17, wherein the adjusting is performed based on a mapping, and wherein the mapping maps each service of a plurality of services including the service activated by the user endpoint device to a respective bandwidth part of a plurality of bandwidth parts.

19. The device of claim 17, the operations further comprising:
detecting the service is no longer in use by the user endpoint device; and
restoring, in response to the detecting that the service is no longer in use by the user endpoint device, the full bandwidth of the radio channel to the user endpoint device.

20. The device of claim 19, the operations further comprising:
determining, after the restoring, the user endpoint device activating a different service that is associated with a different bandwidth part of the radio channel, wherein the different bandwidth part comprises less than an entirety of the full bandwidth; and
adjusting, in response to the activating the different service, the amount of the bandwidth of the radio channel that is allocated to the user endpoint device from the full bandwidth to the different bandwidth part.
